(19) United States
(12) Patent Application Publication
(10) Pub. No.: US 2020/0202334 A1
(43) Pub. Date: Jun. 25, 2020

(54) INDIRECT TRANSACTION PROCESSES ON THE BASIS OF A BLOCKCHAIN ARCHITECTURE

(71) Applicant: ZF Friedrichshafen AG, Friedrichshafen (DE)

(72) Inventors: Alexander GRAF, Friedrichshafen (DE); Michael ROTTER, Friedrichshafen (DE); Susanne FLUG, Ingolstadt (DE); Johannes PECHER, Zirndorf (DE)

(73) Assignee: ZF Friedrichshafen AG, Friedrichshafen (DE)

(21) Appl. No.: 16/641,968

(22) PCT Filed: Aug. 14, 2018
(86) PCT No.: PCT/EP2018/072021

§ 371 Date: Feb. 25, 2020

(30) Foreign Application Priority Data
Aug. 25, 2017 (DE) 10 2017 214 902.7

(51) Int. Cl. G06Q 20/36; H04L 9/06; G06Q 30/02; G06Q 20/40

(52) U.S. Cl. CPC G06Q 20/3674; H04L 9/0637; G06Q 20/202; G06Q 20/405; G06Q 30/0283

(57) ABSTRACT

A transaction device for an owner's terminal for preparing transactions between the owner and a service provider, configured to execute a computer program to calculate a transaction amount for this service, and to generate a message regarding the transaction amount, and an output interface configured to provide this message to the owner. Also described is an intelligent contract for preparing and/or executing transactions between an owner of a terminal and a service provider, a method for preparing such a transaction in a blockchain-based computer network, a computer program product for executing this method, a terminal that has a transaction device, a transaction system for an owner's terminal for executing transactions between the owner and a service provider, a method for an owner's terminal for executing transactions between the owner and a service provider on a blockchain-based computer network, and a computer program product for executing this method.

The invention relates to a transaction device for an owner's terminal for preparing transactions between the owner and a service provider according to claim 1, an intelligent contract for preparing and/or executing transactions between the owner of a terminal and a service provider according to claim 7, a method for an owner's terminal for preparing transactions between the owner and a service provider in a blockchain-based computer network according to claim 11, a computer program product according to claim 13, a terminal with a transaction device according to the invention according to claim 14, a transaction system for an owner's terminal for executing transactions between the owner and the service provider in a blockchain-based computer network according to claim 16, a method for an owner's terminal for executing transactions between the owner and a service provider in a blockchain-based computer network based according to claim 23, and a computer program network according to claim 25.

Blockchain is a term for the technology known from the prior art for generating a decentralized data base.

The following definitions apply to all of the terminology used for describing the invention.

The blockchain is a decentralized data base. Blockchains are known in particular in the field of finance service for executing transactions with digital currencies.

A transactions is an exchange or transfer of values or data. A transaction is a transfer process in particular in which goods and services are transferred between economic entities. A money transfer is a transaction. With a money transfer, the transaction amount is the amount of money in this money transfer, wherein there can also be transaction fees for the money transfer, e.g. the money amount of €1 that is to be transferred can be composed of 99 cents and a 1 cent fee for the platform on which the money transfer is carried out.

Digital currencies are digital means of payment. Digital means of payment are so-called cryptocurrencies, in which the principles of cryptography are used to obtain a distributed, decentralized and secure payment system. One example of a cryptocurrency is the bitcoin.

Blockchain technology is also referred to as “distributed ledger technology” in the field of financial service providers, i.e. a technology for a decentralized ledger. The decentralized ledger is not stored centrally, but instead on numerous different computers on which it is updated. The distributed ledger is automatically obtained through the blockchain, or the decentralized storage of data on different computers. Features of this technology are their decentralization, resistance to modification, and transparency.

Hyperledger is an open-source project of the Linux foundation in which industrial enterprises collectively develop distributed ledgers based on a blockchain. Hyperledger Fabric is a blockchain implemented by IBM in the hyperledger project.

Another example of a cryptocurrency is Ether, with which computing services are counted in the blockchain Ethereum. Ethereum is a blockchain for executing intelligent contracts, so-called smart contracts. There are also smart contracts in other blockchains, e.g. in the Hyperledger Fabric.

An intelligent contract is a computer program that formulates and checks contracts, and/or provides technical support for the negotiation and/or conclusion of a contract.

A blockchain is implemented in a computer network in which all of the computers are interconnected and have equal authority, and can request services as well as provide them. The network members can be divided into different groups, e.g. client and authorization nodes. The computer network can be implemented on the internet.

A computer is a device for processing data, which can process data by means of programmable calculation rules. A computer is able to communicate with other computers in a computer network.

A computer-computer connection in which all of the computers are interconnected and have equal authorization is referred to as a peer-to-peer connection. The opposite of a peer-to-peer connection is the client-server model in which a centralized server offers a service, and a client uses this service.

In simple terms, a blockchain is a chain of blocks in which transaction data are interlinked. The transactions are combined into blocks, checked for validity, and added to the existing chain of blocks in a consensus process. A client thus executes a transaction in the blockchain. Each member knows that this transaction has taken place. As long as the transaction is valid, i.e. regarded as valid by the consensus process, no member is able to modify the legitimacy of the transaction.

The fundamental object of the invention is to create an improved overall system for preparing and executing transactions by means of a blockchain, in particular such an overall system integrated in machines serving for mobility. In particular, the overall system should enable an automatic execution and acceptance of intelligent contracts.

This object is achieved with a transaction device for an owner's terminal for preparing transactions between the owner and the service provider that has the features of claim 1, an intelligent contract for preparing and/or executing transactions between an owner of a terminal and a service provider that has the features of claim 7, a method for an owner's terminal for preparing transactions between the owner and a service provider in a blockchain-based computer network that has the features of claim 11, a computer program that has the features of claim 13, a terminal that has a transaction device according to the invention that has the features of claim 14, a transaction system for an owner's terminal for executing transactions between the owner and a service provider in a blockchain-based computer network according to claim 16, a method for an owner's terminal for executing transactions between the owner and a service provider in a blockchain-based computer network that has the features of claim 23, and a computer program product that has the features of claim 25.

Further developments and advantageous embodiments of the invention are described in the dependent claims.

The transaction device according to the invention for an owner's terminal for preparing transactions between the owner and a service provider contains an input interface that is designed to receive conditions of the service provider for a service and a destination address of this service provider. The transaction device is configured to execute a computer program that contains software code segments for calculating a transaction amount for this service based on a comparison of the conditions for accepting these services defined by the owner for this terminal with the conditions of the service provider, and to generate a message containing at least the transaction amount, the service, and the destination address of the service provider, and preferably these conditions defined by the owner for this terminal. The transaction device also contains an output interface that is configured to output this message to the owner.

A transaction device is a device that processes incoming data and outputs a result. In particular, a transaction device is an electronic device, in particular an electronic circuit, e.g. a central processing unit or a graphics processor.

A terminal is a member with which the owner participates in services from the service provider. The service of the service provider is provided to the terminal. The terminal can be connected to a network termination of a data and/or telecommunications network. By way of example, a vehicle or a vehicle in a fleet of the owner of a terminal. Moreover, a refrigerator, lawn mower, or vehicle is an owner's terminal.

If the owner's terminal is a vehicle, values that are transferred by the transaction, in particular the values of a service ledger for the vehicle, can be, e.g., the oil level and/or mileage, or values for the last vehicle inspection. The service ledger for the vehicle is called a CarPass in conjunction with an electronic wallet, a so-called eWallet, with which it is possible to participate in a blockchain. It is also possible to evaluate the vehicle with the CarPass in order to determine whether or not the vehicle is a good, i.e. valuable, automobile. The value of the vehicle can also be specified in the CarPass, in order to obtain a remaining value of the vehicle by means of a remaining value calculation.

A service is work or service in the economy that does not directly produce goods, but instead is used to solve a problem for a client, or to assume a task. By way of example, purchasing fuel is a service.

An interface is an element between at least two functional units at which logical values are exchanged, e.g. data or physical values, e.g. electric signals, either unidirectionally or bidirectionally. The exchange can be analog or digital. The exchange can also be hard-wired or wireless.

A target address for the service provided, also referred to as the destination address, is an address with which the service provider can be identified. A destination address can be generated with the transaction device, for example, in that an asymmetric cryptographic pair of keys is generated, composed of a public key and a private key. The destination address is then generated from the public key.

The transaction device according to the invention has the advantage that by comparing the conditions defined by the owner for this terminal for accepting the service with the conditions of the service provider, the service provider can be selected by the transaction device that most profitably satisfies the conditions of the owner for this terminal for accepting the service. The transaction device automatically calculates the necessary transaction amount for this service of the respective service provider that best satisfies the conditions of the owner, which is then provided to the owner by the message that is issued. This preparation of transactions between the owner and the service provider has the advantage that the owner can use an arbitrary number of different terminals with little effort to accept services from service providers. In order to be able to pay the transaction amount, e.g. payment of a specific amount, the message contains information regarding the transaction amount and the destination address of the service provider.

Advantageously, the transaction device is a client node of a blockchain-based computer network.

A client node is an electronic device connected to the computer network that can generate transactions and send and/or receive data from other client nodes in order to pay transaction amounts.

The transaction device is preferably configured to provide the message to nodes of a blockchain-based computer network, preferably in the form of a broadcast, wherein authorization nodes in the computer network are configured to validate this message with the blockchain, and to provide this validated message to the owner.

An authorization node is an electronic device that is connected to the computer network. The transactions are checked for validity in the authorization nodes, and attached to the blockchain in a new block. In order to validate the transaction, the authorization nodes execute a compliance algorithm, also referred to as a consensus algorithm. This consensus algorithm ensures that the next block in a blockchain is the only verified block. Furthermore, it is ensured with the consensus algorithm that the blockchain has not been modified by a third party.

One example of a consensus algorithm is the “proof of work” algorithm, in which each block of the blockchain is identified by a hash value and references a precursor block.

A hash value is a value of a hash function, i.e. an identity that represents a large input quantity with a smaller target quantity.

The authorization nodes that execute a proof of work algorithm are also referred to prospector nodes, or mining nodes. A mining node receives transaction messages from the client nodes, in order to validate them in a race with other mining nodes of the blockchain. The first mining node that is able to validate a transaction message generates another block in the blockchain, and indicates this to the other mining nodes.

Further examples of consensus algorithms are “proof of authority,” “proof of stake,” “proof of activity,” “proof of burn,” “proof of capacity,” and “proof of elapsed time” algorithms. The proof of authority algorithm is particularly advantageous. In contrast to the proof of work algorithm, in which numerous mining nodes compete to validate transactions, thus requiring a lot of computing energy, the proof of authority algorithm can use a number of secret keys, so-called authorizations, in order to generate the longest chain.

A broadcast is a transmission in a computer network in which the data packages from a member of the computer network are transmitted to all of the members of the computer network. A broadcast reaches all of the members of a computer network, without having to explicitly name them as recipients.

The transaction can first be executed when the message has been validated. Because in principle the message can be validated by all of the authorization nodes, the conclusion of a transaction via a blockchain-based computer network comprises a particularly secure execution of the transaction.

In a preferred embodiment of the invention the input interface is configured to receive conditions for services of an information service provider, in particular conditions regarding user fees, preferably a road use fee, and/or for services of a service provider, in particular conditions regarding licensing fees, preferably regarding parking fees, refueling fees, fees for a charging station for the terminal, and/or conditions for insurance and/or conditions regarding user fees, preferably regarding fees for a communal use of the terminal.

Road use fees are tolls collected for specific roads. The owner of the terminal can make his terminal available to other members with fees for communal use. Car sharing is enabled with an owner's vehicle, in particular.

It is thus possible for the owner of a terminal to prepare transactions for various services. In particular, it is also possible to obtain insurance.

The transaction device is advantageously a mobile terminal, e.g. a cellular telephone.

In a further development of the invention, the transaction device contains a communication interface that is configured to receive data from the terminal and/or data from the service provider, preferably telematics data, control unit data, and/or actuator data. As a result, the service provider can access control units in the terminal. In particular, a door, window, and/or gas cap in a vehicle can be opened, for example, by a service provider satisfying the respective conditions of the owner for opening a door.

The intelligent contract according to the invention for preparing and/or executing transactions between the owner of a terminal and a service provider contains conditions of the service provider for services of an information service provider, in particular conditions regarding user fees, preferably a road use fee, and/or for services of a service provider, in particular conditions regarding licensing fees, preferably parking fees, refueling fees, fees for a charging station for the terminal, and/or conditions for insurance, and/or conditions regarding user fees, preferably regarding fees for a communal use of the terminal, for providing and/or invoicing for a service, and/or conditions defined by the owner for this terminal for accepting and/or terminating the service, wherein the intelligent contract is executed in an authorization node of a blockchain-based computer network.

Use of an intelligent contract makes a written contract superfluous. Contract clauses for special regulations, contract completion, default risks, service description, and/or suchlike can be executed, and/or enforced therewith.

In a further development of the invention, the transaction device is configured to calculate the transaction amount of an intelligent contract from the service provider, preferably an intelligent contract according to the invention, which contains the conditions of the service provider for the service, wherein the terminal contains an intelligent contract, preferably an intelligent contract according to the invention, which contains conditions defined by the owner for this terminal for accepting the service, wherein a message generated therefrom contains at least a destination address for the intelligent contract of the service provider. As a result, the owner has the possibility, in particular, of providing an intelligent contract for each of his terminals, with which an intelligent contract can be entered into with a respective service provider without the owner's interaction.

The transaction device is preferably configured to inform the owner of termination conditions for terminating an accepted service if these termination conditions defined in the intelligent contract of the service provider or the intelligent contract of the terminal for terminating an accepted service arise, and/or request a decision from the owner to continue or terminate the service. As a result, the owner can be informed after a defined time period has elapsed, if further action is necessary.

By way of example, a filling station can offer refueling services up to a maximum value of €80 as the service provider. The condition is formulated in the intelligent contract of the owner's vehicle that is to be refueled at this filling station, that the refueling is to continue until the fuel tank is filled. If the fuel tank has already been filled with fuel for €56, the refueling service can be terminated prematurely, even though the maximum value of €80 has not yet been reached.

The transaction device is preferably configured to prepare a money transfer between the owner and a service provider, wherein the terminal is preferably a vehicle. This enables an indirect payment. The payment takes place indirectly via the owner's terminal. The owner is asked to make the payment.

The method according to the invention for an owner's terminal for preparing transactions between the owner and a service provider in a blockchain-based computer network comprises the following steps:

receiving conditions of the service provider for a service and a destination address for this service provider;

calculation of a transaction amount for this service based on a comparison of the conditions defined by the owner for this terminal for accepting the service with the conditions of the service provider;

generating a message containing the conditions defined by the owner for this terminal, the transaction amount, the service, and the destination address of the service provider; and

providing this message to the owner.

The method according to the invention advantageously enables a simple and indirect payment by the owner of the terminal.

A transaction device according to the invention is preferably used for executing the method.

The computer program is configured to be uploaded into a memory in a computer. The computer program product contains software code segments with which the steps of the method according to the invention can be executed for preparing transactions when the computer program is running on the computer. The technological problem of preparing transactions in a blockchain-based computer network is solved by the computer program product in that a message is provided to the owner that contains, among other things, the transaction amount.

Computer program products normally comprise a series of commands, with which the hardware executes a specific procedure when the program is loaded that leads to a specific result. When the relevant program is used on a computer, the computer program product brings about a technological effect, specifically the receiving of a message to prepare a transaction between the owner and the service provider.

A memory is a medium for storing data.

Software is an umbrella term for programs and associated data. The complement to software is hardware. Hardware refers to the mechanical and electronic equipment in a data processing system.

The terminal according to the invention that has the transaction device according to the invention contains a terminal output interface that is configured to provide the conditions defined by the owner for this terminal for accepting a service from service providers, and a terminal input interface configured to receive conditions from the service provider for this service, wherein the terminal is configured to select a service provider based on a comparison of the conditions of the service provider with the conditions defined by the owner for this terminal for accepting the service. This means that the decision regarding why which service provider is used depends on the terminal. In particular, the terminal that accepts the service decides why a service should be paid for at a defined transaction amount.

The terminal is preferably configured to select a service provider based on a priority list of service providers stored in an intelligent contract of the terminal. By way of example, it can be defined in an intelligent contract for the owner's vehicle, that this vehicle can only be refueled at specific filling stations. As a result, the terminal only selects the filling stations that the owner has predefined for this vehicle.

The transaction system according to the invention for an owner's terminal for executing transactions between the owner and a service provider in a blockchain-based computer network contains a wallet program in order for the owner to obtain a client node in the computer network when the wallet program is executed on a computer. The transaction system also contains a transaction device that is another client node in the computer network, which is configured to calculate a transaction amount for the service based on a comparison of the conditions defined by the owner for this terminal for accepting a service with the conditions of the service provider, generate a message that contains the these conditions defined by the owner, the transaction amount, the service, and the destination address of the service provider, and provide this message to nodes of the computer network, preferably in the form of a broadcast. Furthermore, the transaction system contains authorization elements that are authorization nodes in the computer network and are executed in order to validate this message using the blockchain, wherein the transaction for the service takes place through the owner with the wallet program based on this validated message.

A wallet program is a computer program that makes a personalized digital wallet available in the digital currency. A client node is generated in a computer network with the wallet program. The wallet program is also referred to as an eWallet.

After it has been verified by the authorization node that the transaction is an authorized payment of the transaction amount, the owner pays the service provider for his terminal. The service provider then provides the service to the terminal.

In a further development of the invention, the transaction system is configured to compare the conditions defined by the owner for this terminal for accepting a service with the conditions of the service provider, based on an intelligent contract of the service provider, preferably an intelligent contract according to the invention, and an intelligent contract of the terminal, preferably an intelligent contract according to the invention, wherein the message contains at least a destination address of the intelligent contract of the service provider. This is of particular advantage when the owner has provided an intelligent contract to each of numerous terminals, which he manages via the wallet program. As a result, the owner can pay indirectly for each of his terminals.

The transaction device is preferably configured to inform the owner of the termination conditions and/or request a decision from the owner to continue or terminate the service if the termination conditions defined in the intelligent contract of the service provider or in the intelligent contract of the terminal for terminating an accepted service arise, wherein the wallet program is configured to terminate the service. The owner can still send information to the service provider as a contractual partner, in order to complete the service process. If a service process that the owner has previously paid for in full is prematurely discontinued prior to fulfilling the service associated with the payment, the remaining amount can be refunded to the owner by the service provider.

The wallet program is preferably configured to obtain the other client nodes for the transaction device.

Advantageously, the wallet program can be executed on an owner's mobile terminal, wherein the wallet program is preferably a mobile application software, a so-called app. As a result, an app is provided for a transaction system according to the invention.

In a further development of the invention the wallet program is configured to execute transactions for numerous owner's terminals for respective services based on respective validated messages based on respective intelligent contracts specific to the terminal, preferably intelligent contracts according to the invention specific to the respective terminal. As a result, the owner can pay indirectly for services for a fleet of vehicles with the wallet program by executing transactions.

In a particularly advantageous embodiment of the transaction system according to the invention, the transactions are prepared with a transaction device according to the invention.

The method according to the invention for an owner's terminal for executing transactions between the owner and a service provider in a blockchain-based computer network comprises the following steps:

obtaining a client node for the owner in the computer network through a wallet program when the wallet program is executed on a computer;

forming a further client node in the computer network by a transaction device;

calculating a transaction amount for the service by means of the transaction device based on a comparison of the conditions defined by the owner for this terminal for accepting a service with the conditions of the service provider;

generating a message with the transaction device that contains these conditions defined by the owner, the transaction amount, the service, and a destination address of the service provider;

providing this message to the nodes of the computer network, preferably in the form of a broadcast;

validating this message using this blockchain through authorization nodes in the computer network; and

paying for the service by the owner with the wallet program, based on this validated message.

With this method it is particularly easy to pay transactions indirectly.

A transaction system according to the invention is preferably used for executing the method.

The other computer program product according to the invention is configured to be loaded into a memory of a computer, and contains software code segments with which the steps of the method according to the invention for executing transactions are executed when the computer program product runs on the computer. The technological problem of executing transactions in a blockchain-based computer network is solved by the computer program product, etc., in that a message is provided to the owner that contains, among other things, the transaction amount, and this message is validated.

The invention shall be explained comprehensively in reference to the following figures. Therein:

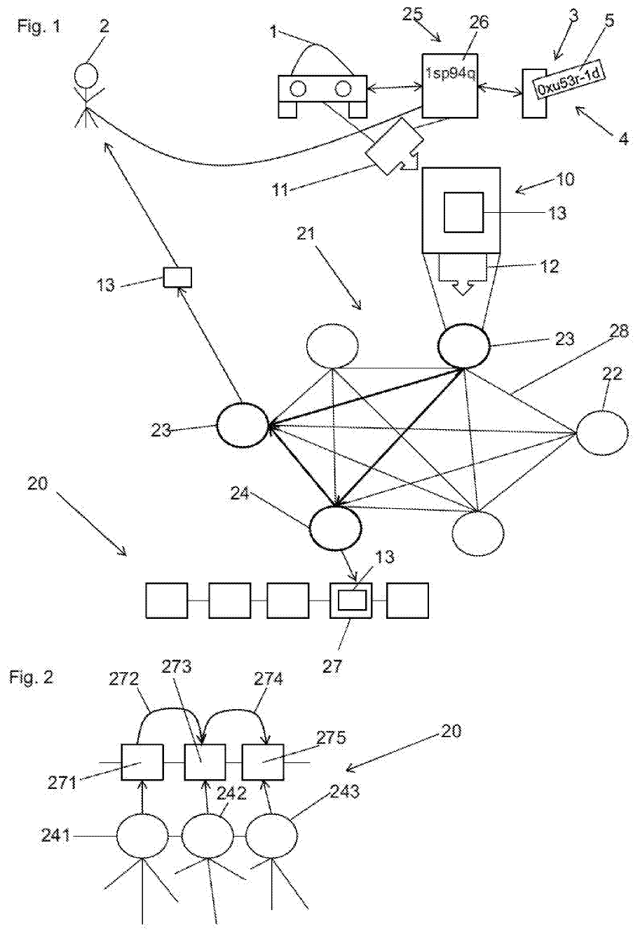

FIG. 1: shows an exemplary embodiment of the transaction device according to the invention;

FIG. 2: shows an exemplary embodiment of a blockchain;

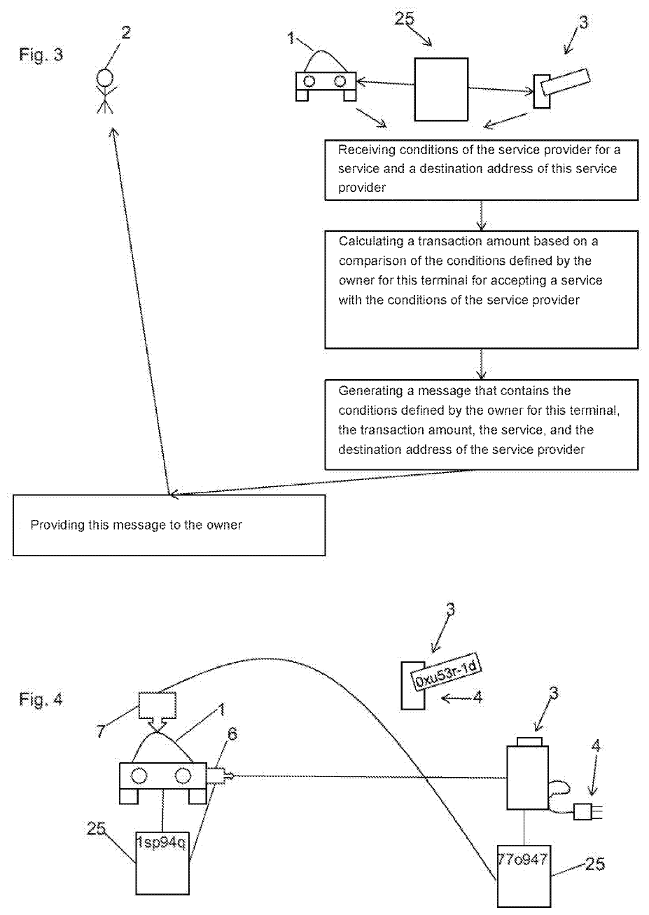

FIG. 3: shows an exemplary embodiment of the method according to the invention for preparing a transaction;

FIG. 4: shows an exemplary embodiment of a terminal according to the invention;

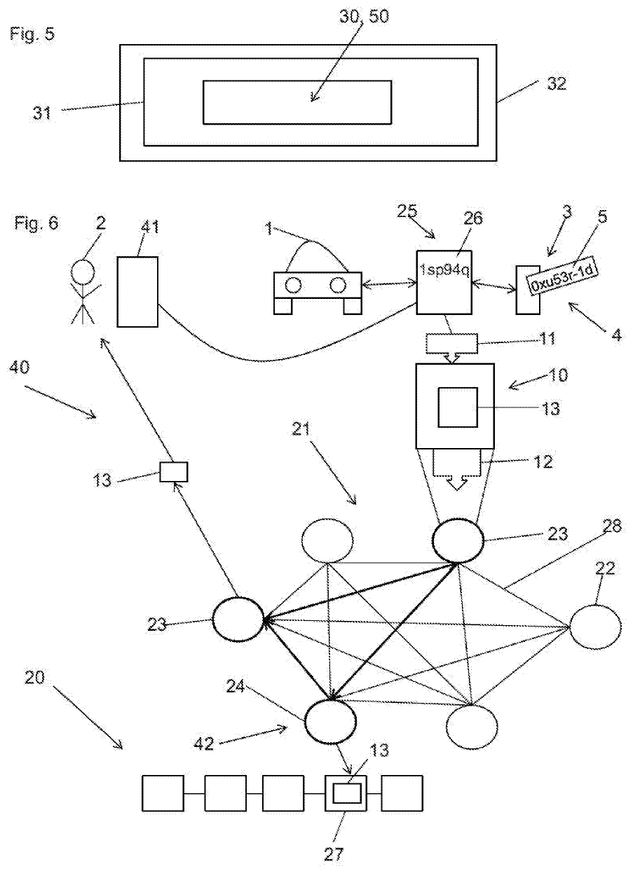

FIG. 5: shows an exemplary embodiment of the computer program product according to the invention;

FIG. 6: shows an exemplary embodiment of the transaction system according to the invention; and

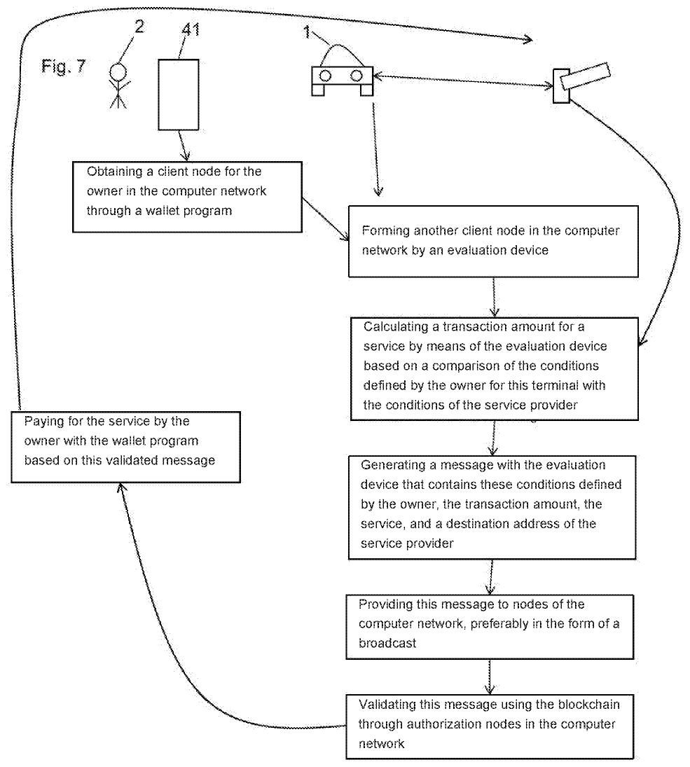

FIG. 7: shows an exemplary embodiment of a method according to the invention for executing a transaction.

Identical reference symbols designate identical or functionally similar reference components in the figures. Only the relevant reference components are numbered in the respective figures.

In FIG. 1, the terminal 1 of an owner 2 is an owner's 2 vehicle. The owner 2 in FIG. 1 is an actual person. The owner 2 can also own a fleet of numerous terminals 1. The following explanations can thus be applied to each terminal 1 in an owner's 2 vehicle fleet.

The terminal 1 accepts a service 4 from a service provider 3. The service 4 is the provision of a parking space in a parking lot blocked by a gate by a parking lot manager. The service provider 3 is the parking lot manager.

In order to accept the service 4 and prepare a transaction, the terminal 1 has a transaction device 10. The transaction device 10 contains an input interface 11. The transaction device 10 receives the conditions of the service provider 3 for the service 4 of parking via the input interface 11, e.g. a parking fee per time unit, and a destination address 5 of this service provider 3. The destination address 5 is the address by means of which the service provider 3 can be identified. The destination address 5 can be generated with the transaction device 10, for example, in that an asymmetrical cryptographic pair of keys is generated, composed of a public key and a private key.

The preparation of the transaction takes place in FIG. 1 by means of an intelligent contract 25 between the service provider 3 and the terminal 1. The service provider 3 receives the conditions stipulated in the intelligent contract 24 by the owner 2 of the terminal for accepting this service 4. After receiving these conditions, the service provider 3 sends the conditions for his service 4 to the terminal 1. The transaction device 10 compares the conditions defined by the owner 2 for this terminal 1 for accepting the service 4 with the conditions of the service provider 3 in order to calculate a transaction amount for this service 4, and to generate a message 13 that contains the conditions defined by the owner 2 for this terminal 1, the transaction amount, the service 4, and the destination address 5 of the service provider 3. This message 13 is provided to the owner 2 via an output interface in the transaction device 10. The intelligent contract 25 and the message 13 are executed in a computer network 21 that has a blockchain 20 basis.

The transaction device 10 is a client node 23 in the computer network 21. The computer network 21 is composed of numerous nodes 22, wherein each node 22 is connected to each of the other nodes 22 in the computer network 21. The client node 23 generates the message 13 and sends it to the other nodes 22 in the computer network 21. Among other things, the message is sent to authorization nodes 24 in the computer network 21. Authorization nodes 24 validate the message 13 according to a specific consensus algorithm, e.g. the proof of work algorithm. In this context, an authorization node 24 can also be referred to as a prospector node or mining node. The validated message 13 is entered into a new block 27 of the blockchain 20.

FIG. 2 illustrates the generation of new blocks in a blockchain 20. A first block 271 of the blockchain 20 is created by a first authorization node 241. The first authorization node 241 has generated a first hash value 272 for the first block 271. The first block 271 in the blockchain 20 is identified by the first hash value 272. The second block 273 in the blockchain 20 generated by the second authorization node 242 is identified by the second hash value 274 and references the first block 271 by transmitting the first hash value 272 from the first block 271 to the second block 273. The third block 275 is generated by the authorization node 243, and references the second block 273 by transmitting the second hash value 274 form the second block 273 to the third block 275 referenced on the preceding block 273.

The hash value is the function value of a hash function. Characters of an arbitrary length can be brought into a more compact form with the hash function. The hash value can be encoded as a hexadecimal character string. The hash value should be selected such that it is not possible to generate the original content from it. Furthermore, different input characters should not be assigned to the same hash value.

The authorization node 24 that validates the message 13 and enters it into a further block 27 of the blockchain 20 transmits the validated message to another client node 23, via which the validated message 13 is provided to the owner 2.

Conditions of the service provider 3 for a service 4 and a destination address 5 of the service provider 3 are obtained by means of intelligent contracts 25 in FIG. 3. An intelligent contract 25 is executed between the terminal 1 and the service provider 3. A corresponding transaction amount is calculated for this service 4 based on a comparison of the conditions defined by the owner 2 for this terminal 1 for accepting the service with the conditions of the service provider 3. A message 13 is subsequently generated that contains the conditions defined by the owner 2 for this terminal 1, the transaction amount, the service 4, and the destination address 5 of the service provider 3. This message 13 is then provided to the owner 2 of the terminal 1.

FIG. 4 shows a terminal 1 in the form of a vehicle that has a terminal input interface 7 and a terminal output interface 6. The terminal 1 has an intelligent contract 25 assigned to it that contains the conditions defined by the owner 2 of this vehicle 1 for accepting a service 4. The terminal 1 receives conditions for services 4 from the service provider 3 via the terminal input interface 7, wherein these conditions are contained in intelligent contracts 25 of the service provider 3. The terminal 1 is configured to select a service provider 3 based on a comparison of the conditions of the service provider 3 with the conditions defined by the owner 2 for this terminal 1 for accepting a service 4. In particular, a priority list of service providers 3 is stored in the intelligent contract 25 of the terminal 1, from which the terminal 1 can select a service provider 3. The intelligent contract 25 of the terminal 1 contains a priority list for filling stations for the terminal 1 in FIG. 4, in particular electric charging stations. The vehicle can then select a service provider 3 through the intelligent contract 25 of the terminal 1 and a corresponding intelligent contract 25 of a service provider 3, which most profitably fulfills the conditions for the owner 2.

FIG. 5 shows a computer program 30 for executing the method for preparing a transaction and a computer program product 50 for executing a transaction. The computer program products 30 and 50 are loaded into a memory 31 in a computer 32.

The owner 2 of a terminal 1 has a wallet program 41 in FIG. 6. The owner 2 can execute intelligent contracts 25 for terminals 1 with this wallet program 41, and pay a corresponding transaction amount to the service provider 3 for a selected intelligent contract 25. The transaction system 40 contains the intelligent contract 25 of the terminal and a service provider 3 and a blockchain-based computer network 21 as a substantial component of the wallet program 41 of the owner 2. The transaction device 10 forms a client node in this computer network 21. An authorization element 42 is an authorization node 24 for validating the message 13. The wallet program 41 forms another client node 23, via which the owner the receives the validated message, and can pay the transaction amount.

FIG. 7 shows the method for executing a transaction between the owner 2 and a service provider 3 in a computer network 21 with a blockchain 20 basis. First, a client node 24 is obtained for the owner 2 in the computer network 21 by a wallet program 41, when the wallet program 41 is executed on a computer 31. A further client node 23 is subsequently formed in the computer network by the transaction device 10. A transaction amount for a service of the service provider 3 is calculated by means of the transaction device 10 based on a comparison of the conditions defined by the owner 2 for this terminal 1 for accepting a service with the conditions of the service provider 3. A message 13 is subsequently generated with the transaction device 10. This message contains the conditions defined by the owner 2, the transaction amount, the service 4, and a destination address 5 of the service provider. This message is then provided to nodes 22 of the computer network 21 by means of a broadcast 28, and validated by authorization nodes 24 in the computer network 21 using the blockchain 20. Lastly, the service 4 is paid for by the owner 2 with the wallet program 41 based on this validated message 13.

### REFERENCE SYMBOLS

1 terminal

2 owner

3 service provider

4 service

5 destination address

6 terminal output interface

7 terminal input interface

10 transaction device

11 input interface

12 output interface

13 message

14 communication interface

20 blockchain

21 computer network

22 node

23 client node

24 authorization node

241 first authorization node

242 second authorization node

243 third authorization node

25 intelligent contract

26 destination address

27 block

271 first block

272 first hash value

273 second block

274 second hash value

275 third block

28 broadcast

30 computer program product

31 memory

32 computer

40 transaction system

41 wallet program

42 authorization element

50 computer program product

1. A transaction device for a terminal of an owner for preparing transactions between the owner and a service provider, the transaction device comprising:
an input interface configured to receive conditions of the service provider for a service and a destination address of the service provider; wherein the transaction device is configured to execute a computer program that causes the transaction device to:
calculate a transaction amount for the service based on a comparison of the conditions defined by the owner of the terminal for accepting the service with the conditions of the service provider; and
generate a message that contains at least the transaction amount, the service, and the destination address of the service provider; and
an output interface configured to provide the message to the owner.

2. The transaction device according to claim 1, wherein the transaction device is a client node in a computer network with a blockchain basis.

3. The transaction device according to claim 1, wherein the transaction device is configured to provide the message to nodes in a computer network with a blockchain basis, wherein authorization nodes of the computer network are configured to validate the message using the blockchain, and to provide the validated message to the owner.

4. The transaction device according to claim 1, wherein the input interface is configured to receive at least one of conditions for services of an information service provider, conditions for services of a service provider, conditions for insurance, or conditions regarding user fees.

5. The transaction device according to claim 1, wherein the transaction device is a mobile terminal.

6. The transaction device according to claim 1, wherein the transaction device has a communication interface configured to receive at least one of telematic data, control unit data, or actuator data of the terminal or of the service provider.

7. (canceled)

8. The transaction device according to claim 1, wherein the transaction device is configured to calculate the transaction amount of an intelligent contract of the service provider containing the conditions of the service provider for the service,
wherein the terminal contains an intelligent contract of the terminal, that contains the conditions defined by the owner for the terminal for accepting the service,
wherein the message generated by the transaction device contains at least a destination address for the intelligent contract of the service provider.

9. The transaction device according to claim 8, wherein the transaction device is configured to at least one of inform the owner of termination conditions or request a decision from the owner to continue or terminate the service if termination conditions defined in the intelligent contract of the service provider or in the intelligent contract of the terminal for terminating an accepted service arise.

10. The transaction device according to claim 1, wherein the transaction device is configured to prepare a money transfer between the owner and the service provider, wherein the terminal is preferably a vehicle.

11. A method for a terminal of an owner for preparing transactions between the owner and a service provider in a computer network with a blockchain basis, the method comprising:
receiving conditions of the service provider for a service and a destination address of the service provider;
calculating a transaction amount for the service based on a comparison of conditions defined by the owner for the terminal for accepting the service with the conditions of the service provider;
generating a message that contains the conditions defined by the owner for the terminal, the transaction amount, the service, and the destination address of the service provider; and
providing the message to the owner.

12. The method according to claim 11, wherein the method is executed by a transaction device comprising:
an input interface configured to receive the conditions of the service provider and the destination address of the service provider;
a computer program that causes the transaction device to perform various operations; and
an output interface configured to provide the message to the owner.

13. (canceled)

14. The terminal comprising the transaction device according to claim 1, the terminal further comprising:
a terminal output interface configured to provide the conditions defined by the owner for the terminal for accepting the service of the service provider;
a terminal input interface configured to receive the conditions of the service provider for the service;
wherein the terminal is configured to select the service provider based on a comparison of the conditions of the service provider with the conditions defined by the owner for this terminal for accepting the service.

15. The terminal according to claim 14, wherein the terminal is configured to select the service provider based on a priority list of service providers, preferably stored in an intelligent contract of the terminal.

16. A transaction system for a terminal of an owner for executing transactions between the owner and a service provider in a computer network with a blockchain basis, comprising:
a wallet program for obtaining a client node in the computer network for the owner when the wallet program is executed on a computer;
a transaction device comprising a further client node in the computer network, configured to:
calculate a transaction amount for the service based on a comparison of the conditions defined by the owner for the terminal for accepting a service with the conditions of the service provider,
generate a message that contains the conditions defined by the owner, the transaction amount, the service, and a destination address of the service provider, and
provide the message to nodes of the computer network;
authorization elements that are authorization nodes in the computer network and are configured to validate the message using the blockchain, wherein
the transaction for the service takes place through the owner with the wallet program based on the validated message.

17. The transaction system according to claim 16, wherein the transaction system is configured to execute the comparison of the conditions defined by the owner for the terminal for accepting the service with the conditions of the service provider based on an intelligent contract of the service provider, and an intelligent contract of the terminal, wherein the message contains at least a destination address of the intelligent contract of the service provider.

18. The transaction system according to claim 17, wherein the transaction device is configured to at least one of inform the owner of termination conditions or request a decision from the owner to continue or terminate the service if termination conditions for terminating an accepted service defined in the intelligent contract of the service provider or in the intelligent contract of the terminal arise, wherein the wallet program is configured to terminate the service.

19. The transaction system according to claim 16, wherein the wallet program is configured to obtain the further client node for the transaction device.

20. The transaction system according to claim 16, wherein the wallet program can be executed on a mobile terminal of the owner, wherein the wallet program is preferably a mobile application software.

21. The transaction system according to claim 16, wherein the wallet program is configured to execute transactions for numerous terminals of the owner for respective services based on respective validated messages, based on respective intelligent contracts specific to the terminal.

22. (canceled)

23. A method for a terminal of an owner for executing transactions between the owner and a service provider in a computer network with a blockchain basis, the method comprising:
obtaining a client node for the owner in the computer network through a wallet program when the wallet program is executed on a computer;
forming a further client node in the computer network by a transaction device;
calculating a transaction amount for the service by means of a transaction device, based on a comparison of conditions defined by the owner for the terminal for accepting the service with conditions of the service provider;
generating a message with the transaction device that contains the conditions defined by the owner, the transaction amount, the service, and a destination address of the service provider;
providing the message to nodes of the computer network;
validating the message using the blockchain through authorization nodes in the computer network; and
paying for the service by the owner with the wallet program based on the validated message.

24. (canceled)

25. (canceled)
